(19) United States
(12) Patent Application Publication
(10) Pub. No.: US 2025/0103199 A1
(43) Pub. Date: Mar. 27, 2025

(54) Information Processing System, Information Processing Method, and Program

(71) Applicant: Knowledge Work Inc., Tokyo (JP)

(72) Inventor: Koji ASANO, Tokyo (JP)

(21) Appl. No.: 18/900,444

(22) Filed: Sep. 27, 2024

(30) Foreign Application Priority Data
Sep. 27, 2023 (JP) 2023-166456

(51) Int. Cl. G06F 3/04845; G06F 3/0483

(52) U.S. Cl. CPC G06F 3/04845; G06F 3/0483

(57) ABSTRACT

An information processing system comprising: a screen display unit that displays on a screen a document image representing document data including a plurality of pages; and an enlarging display unit that, when a pointer is located on the document image, enlarges and displays one of the plurality of pages of the document data and changes the page to be displayed according to a movement of the pointer on the displayed page.

### TECHNICAL FIELD

The present invention relates to an information processing system, an information processing method, and a program.

### BACKGROUND ART

Enlarging display items on a screen has been performed (see, for example, Patent Document 1).

### CITATION LIST

### Patent Literature

[PTL 1] Japanese Unexamined Patent Application Publication No. 2001-056729

### SUMMARY OF THE INVENTION

### Technical Problem

However, with the technology described in Patent Document 1, in the case of a document containing multiple pages, only the cover page can be enlarged, making it difficult to transition to other pages.

The present invention has been made in view of such a background, and an object thereof is to provide a technology that enables efficient confirmation of the contents of a document.

### Solution to Problem

The main invention to solve the above-mentioned problems is an information processing system comprising: a screen display unit that displays on a screen a document image representing document data including a plurality of pages; and an enlarging display unit that, when a pointer is located on the document image, enlarges and displays one of the plurality of pages of the document data and changes the page to be displayed according to a movement of the pointer on the displayed page.

Other problems disclosed in this application and their solutions will be clarified in the description of the embodiments of the invention and the drawings.

### Advantageous Effects of the Invention

According to the present invention, the contents of a document can be efficiently checked.

### BRIEF DESCRIPTION OF DRAWINGS

FIG. 1 is a diagram showing an example of the overall configuration of the information processing system according to the present embodiment.

FIG. 2 is a diagram showing an example of the hardware configuration of the management server 2.

FIG. 3 is a diagram showing an example of the software configuration of the management server 2.

FIG. 4 is a diagram illustrating an example of a concatenated image 40.

FIG. 5 is a diagram showing an example of the software configuration of the user terminal 1.

FIG. 6 is a diagram showing an example of a screen 30 displayed by the screen display unit 112.

FIG. 7 is a diagram illustrating how the enlarging display unit 114 enlarges the display.

FIG. 8 is a diagram illustrating the determination of pages.

FIG. 9 is a diagram illustrating the operation of the information processing system.

FIG. 10 is a diagram showing an example of a screen 30 displayed by the screen display unit 112.

FIG. 11 is a diagram illustrating how the enlarging display unit 114 enlarges the display.

FIG. 12 is a diagram illustrating how the enlarging display unit 114 enlarges the display.

### DESCRIPTION OF EMBODIMENTS

### <System Overview>

The following is a description of an information processing system according to one embodiment of the present invention.

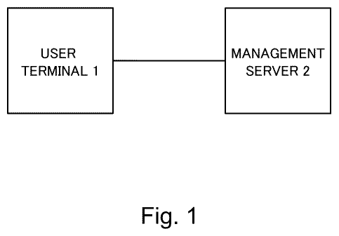

FIG. 1 shows an example of the overall configuration of the information processing system according to the present embodiment. The information processing system of this embodiment includes a management server 2. The management server 2 is communicatively connected to a user terminal 1 via a communication network. The communication network is, for example, the Internet, and is constructed using a public telephone line network, a cellular phone line network, wireless communication channels, Ethernet (registered trademark), etc.

The user terminal 1 is a computer operated by a user. The user terminal 1 can be, for example, a smartphone, a tablet computer, or a personal computer.

The management server 2 may be a general-purpose computer, such as a workstation or a personal computer, or it may be logically realized by cloud computing.

### <Management Server>

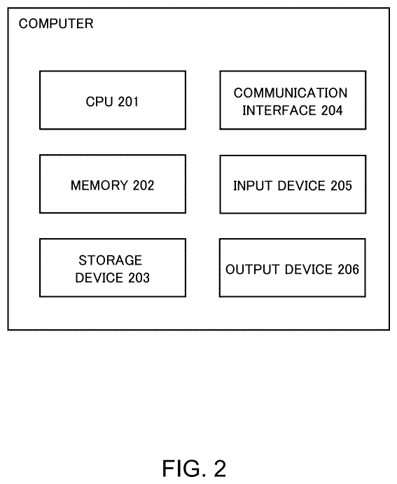

FIG. 2 shows an example of the hardware configuration of the management server 2. The configuration shown in the figure is an example, and other configurations may be used. The management server 2 is equipped with a CPU 201, a memory 202, a storage device 203, a communication interface 204, an input device 205, and an output device 206. The storage device 203 is, for example, a hard disk drive, a solid-state drive, or a flash memory that stores various data and programs. The communication interface 204 is an interface for connecting to the communication network 3, such as an adapter for connecting to Ethernet (registered trademark), a modem for connecting to a public telephone line network, a wireless communicator for wireless communication, or USB (Universal Serial Bus) connectors or RS-232C connectors for serial communication. The input device 205 is, for example, a keyboard, a mouse, a touch panel, buttons, or a microphone for inputting data. The output device 206 is, for example, a display, a printer, or a speaker for outputting data. Each functional part of the management server 2 described below is realized by the CPU 201 reading a program stored in the storage device 203 into the memory 202 and executing it, and each storage part of the management server 2 is realized as a part of the storage space provided by the memory 202 and the storage device 203.

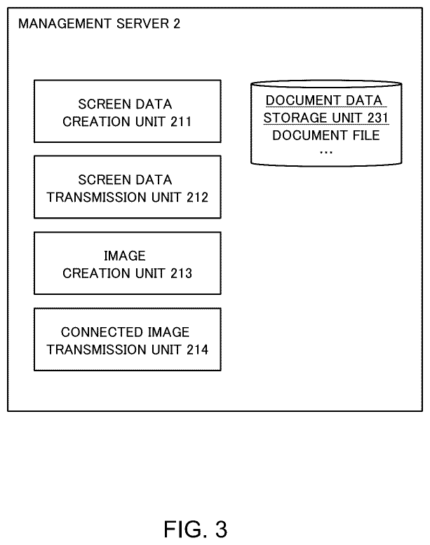

FIG. 3 shows an example of the software configuration of the management server 2. Management server 2 is equipped with a document data storage unit 231, a screen data creation unit 211, a screen data transmission unit 212, an image creation unit 213, and a concatenated image transmission unit 214.

The document data storage unit 231 stores document data. Document data includes multiple pages. The document data can be, for example, a file in PDF format, word processor format, presentation format, spreadsheet format, etc. The document data storage unit 231 can be realized as a file system, for example, and the document data can be realized as a file managed by the file system. The document data storage unit 231 can be realized by an RDBMS, object database, or the like. The document data storage unit 231 may also be realized as an external storage. For example, the document data storage unit 231 may be realized as a cloud storage service, and the document data may be obtained by accessing the cloud storage.

The document data storage unit 231 can store images showing document data (hereinafter referred to as thumbnail images). The thumbnail image may be, for example, a cover page of the document data. The thumbnail image may be, for example, an image converted from one of the pages included in the document data. The thumbnail image can be stored in the document data storage unit 231, for example, as an image file such as a PNG format file. The document data storage unit 231 can store an image of each page included in the document data (hereinafter referred to as a page image). The document data storage unit 231 can also store a concatenated image in which page images showing each of the plurality of pages included in the document data are arranged and concatenated in one direction (hereinafter referred to as a concatenated image). The one direction need not be linear. Also, rather than being in one direction, the arrangement may appear random as long as it follows predetermined rules. In other words, the arrangement should be such that when a page is specified, the location of the specified page in the concatenated image can be determined. The page image and the concatenated image can be registered when the document data is registered in the document data storage unit 231. The page image and the concatenated image can also be stored in the document data storage unit 231 as image files, such as PNG format files, for example. The page image and the concatenated image may not be stored in the document data storage unit 231 in advance, but may be created based on the document data as necessary. The conversion of pages in the document data into images can be performed, for example, by having them exported into images using PDF editing and processing display software, word processing software, presentation software, or the like.

The document data stored by the document data storage unit 231 can also be updated by the user. For example, the management server 2 can provide document data in response to a request from the user terminal 1 and update the document data stored in the document data storage unit 231 by receiving the uploaded document data from the user terminal 1.

The screen data creation unit 211 creates screen data for displaying screens that list document data. The screen data can be written in HTML, for example. The screen can display a list of thumbnail images showing documents. The screen data creation unit 211 can read the thumbnail images stored in the document data storage unit 231 in response to a request (e.g., HTTP request) from the user terminal 1, create the screen data, and respond to the user terminal 1.

The screen data creation unit 211 adds to each thumbnail image information that identifies the document data (hereinafter referred to as the document ID. The document ID may be, for example, a unique character string, or it may be a path name, URL, etc.). For example, the screen data creation unit 211 can set the document ID in the ID attribute of the IMG tag that displays the thumbnail image.

The screen data transmission unit 212 transmits the screen data created by the screen data creation unit 211 to the user terminal 1. The screen data transmission unit 212 can transmit a program (which can be written in JavaScript, for example) to realize the functions of user terminal 1 as described below, together with the screen data.

The image creation unit 213 creates images based on document data. In this embodiment, the image creation unit 213 creates a thumbnail image, a page image, and a concatenated image based on the document data. The image creation unit 213 stores the created thumbnail image, page image, and concatenated image in the document data storage unit 231 in association with the document data. In this embodiment, the image creation unit 213 connects each page image in the horizontal direction (description direction, left to right for Japanese). The concatenated image can be a single horizontal image having the width of the page image times the number of pages and the height of the page image. If there are more than a predetermined number of pages (e.g., 10), the pages may be folded and concatenated to form multiple lines. The image creation unit 213 can, for example, create a row-connected image with all the pages arranged in a row in the horizontal direction for each predetermined number of pages, and then create a concatenated image by arranging the created row-connected images in the vertical direction. The image creation unit 213 can create a thumbnail image, a page image, and a concatenated image to be registered together with the document data in the document data storage unit 231 when the document data is registered in the document data storage unit 231. The image creation unit 213 may also create thumbnail images, page images, and concatenated images in response to a request from the user terminal 1.

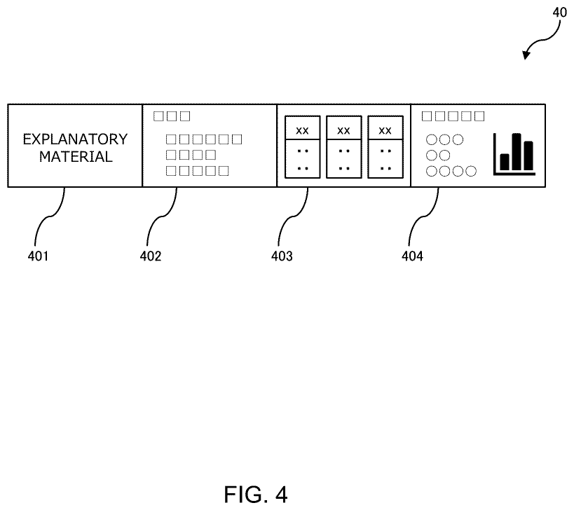

FIG. 4 illustrates an example of a concatenated image 40. In the example in FIG. 4, the document data contains four pages, and the concatenated image 40 consists of images 401 through 404 for the four pages, arranged horizontally. The concatenated image 40 is composed as a single image.

The concatenated image transmission unit 214 transmits the concatenated image to the user terminal 1. The concatenated image transmission unit 214 can, for example, respond to a request from the user terminal 1 by reading the concatenated image from the document data storage unit 231. The request from user terminal 1 may include a document ID that identifies the document data, and the concatenated image transmission unit 214 can read the concatenated image corresponding to the document data identified by the document ID.

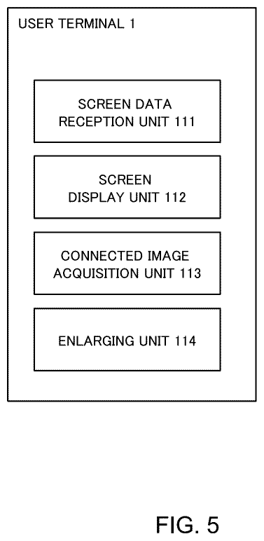

FIG. 5 shows an example of the software configuration of user terminal 1. User terminal 1 is equipped with a screen data receiving unit 111, a screen display unit 112, a concatenated image acquisition unit 113, and an enlarging display unit 114.

The screen data receiving unit 111 receives screen data from the management server 2. The screen data receiving unit 111 can, for example, send an HTTP request by a Web browser to the management server 2 and obtain the screen data in response to the request.

The screen display unit 112 displays screens based on screen data. The screen display unit 112 can, for example, display a Web page (screen) based on an HTML file as a function of a Web browser. As described above, the screen lists thumbnail images (document images) showing document data.

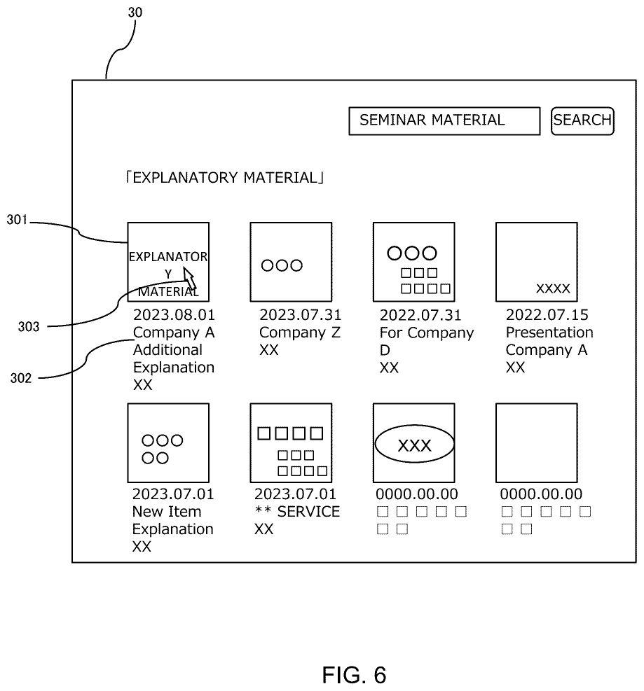

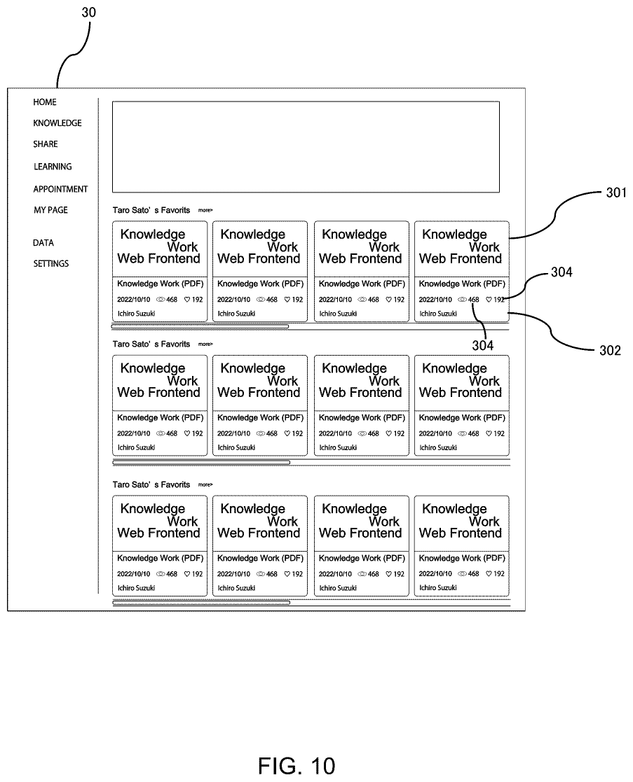

FIG. 6 shows an example of screen 30 displayed by screen display unit 112. FIG. 10 also shows another example of screen 30. Screen 30 lists thumbnail images 301 of document data. In the example of FIG. 6, the attributes 302 of the document data (e.g., creation date, title, creator, etc.) are displayed with the thumbnail images 301. In the example in FIG. 10, the attributes 302 of the document data are also displayed at the bottom of the thumbnail image 301. In this case, the document data storage unit 231 of the management server 2 can store the attributes together with the document data, and the screen data creation unit 211 can create screen data so that the attributes are displayed together with the thumbnail images. In the example in FIG. 10, the attribute 302 includes the number of times the document data has been viewed (number of views 304) and the number of “likes” sent by users who have viewed the document data (number of likes 305). This allows users to know which document data the users in the organization are interested in.

The concatenated image acquisition unit 113 can send a request to the management server 2 to acquire a concatenated image when a pointer such as a mouse is located on a thumbnail image on the screen (when a mouse-over event occurs). The concatenated image acquisition unit 113 can set the document ID corresponding to the thumbnail image on which the mouse-over event occurred (e.g., the ID attribute of the IMG element on which the event occurred) in the request. The concatenated image acquisition unit 113 can acquire the concatenated image sent from the management server 2 in response to the request. The concatenated image acquisition unit 113 may acquire the concatenated image in advance before the event occurs. In this case, the concatenated image acquisition unit 113 can store the concatenated image in a cache.

The enlarging display unit 114 magnifies and displays one of the multiple pages of document data (thumbnail image) when the pointer is located on the thumbnail image. The enlarging display unit 114 can, for example, display a pop-up dialog and display the page image in the dialog. In this embodiment, the enlarging display unit 114 cuts out and displays a portion (one page) of the concatenated image.

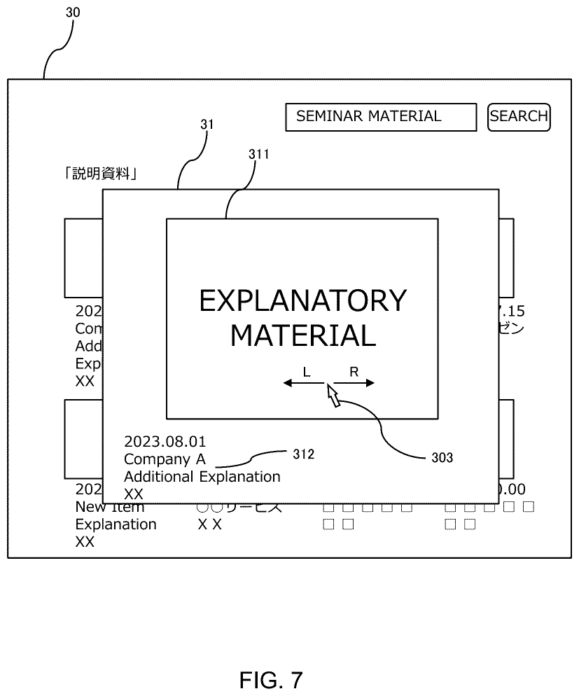

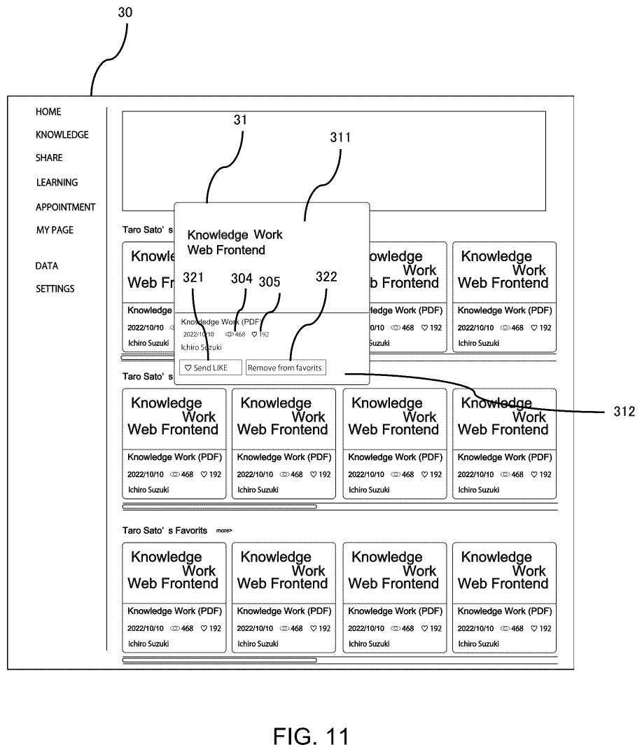

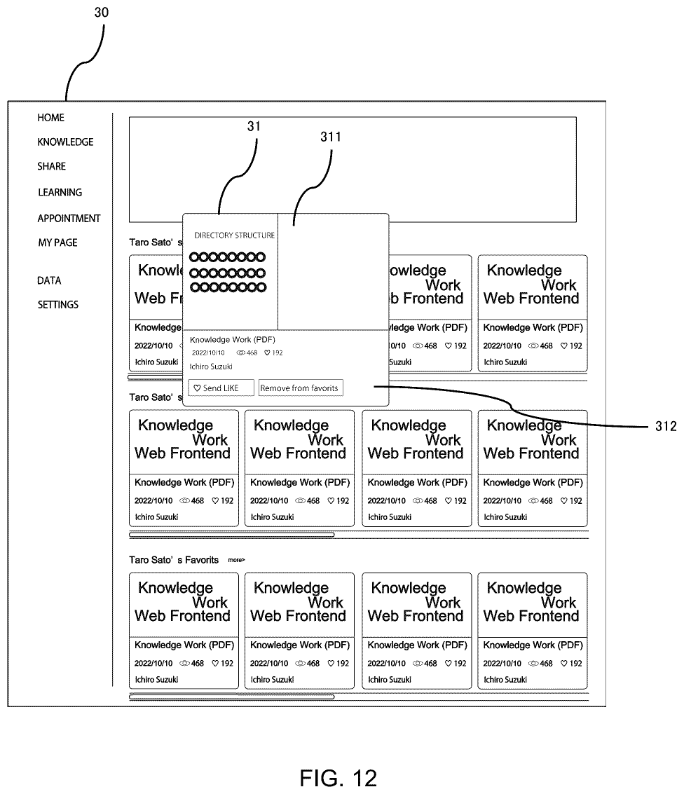

FIG. 7 illustrates the enlarged view by the enlarging display unit 114. FIGS. 11 and 12 also illustrate the enlarging display in another example. In FIGS. 6 and 10, when the pointer 303 is located on the thumbnail image 301, the enlarging display unit 114 displays a pop-up dialog 31 as shown in FIGS. 7 and 11, and in the dialog 31, an image 311 of the page is displayed. In the examples of FIGS. 7, 11 and 12, the attributes 312 of the document data are also displayed in the dialog 31, along with the image 311 of the page. In the examples of FIGS. 11 and 12, the attributes 312 of the document data include the number of views 304 and the number of likes 305, as described above. In the examples of FIGS. 11 and 12, a “Send Like” button 321 is displayed in the dialog 31, and when this button 321 is pressed, the number of likes of the document data is counted up. A limit may be set so that no more than one like can be sent from the same user. The “Remove from Favorites” button 322 is displayed in the dialog 31, and when this button 322 is pressed, this document data is removed from the user's “Favorites” list. If this document data is not in the user's favorites list, the button 322 can be displayed as “Add to Favorites”, and when the button 322 is pressed, this document data can be added to the favorites list. From the favorites list (not shown), the user can select and view the document data that they have added to their favorites list.

The enlarging display unit 114 changes the page to be displayed according to the movement of the pointer on the displayed page. The enlarging display unit 114 can change the portion to be extracted from the concatenated image according to the movement of the pointer. The enlarging display unit 114 can advance or reverse the displayed page by the number of pages corresponding to the amount of pointer movement. The enlarging display unit 114 can advance or reverse the displayed pages by two or more pages, not just to the next or previous page. For example, the enlarging display unit 114 can advance or reverse by the number of pages corresponding to the distance of pointer movement. The pointer movement may be a simple movement (mouse-over), a movement while pressing a mouse button (drag), or a swipe on a display device such as a mobile terminal. The enlarging display unit 114 may also change the page to be displayed according to the speed of pointer movement. For example, the enlarging display unit 114 can advance or reverse by the number of pages corresponding to the pointer movement speed. The number of pages to advance or reverse may increase with faster pointer movement speed, or may increase with slower pointer movement speed. In this embodiment, the page to be displayed is changed according to the horizontal movement of the pointer. In the example of FIG. 7, the page displayed as image 311 is changed when the pointer 303 moves more than a predetermined distance in the direction of arrow L or arrow R. FIG. 12 shows how the image 311 of the page has changed when the pointer is moved on the dialog 31 displayed on the screen 30 in FIG. 11. Through the examples shown in FIG. 10 to FIG. 12, the attributes 312 display the number of views 304 and the number of likes 305, and other attributes such as file name, update date and time, and creator are also displayed.

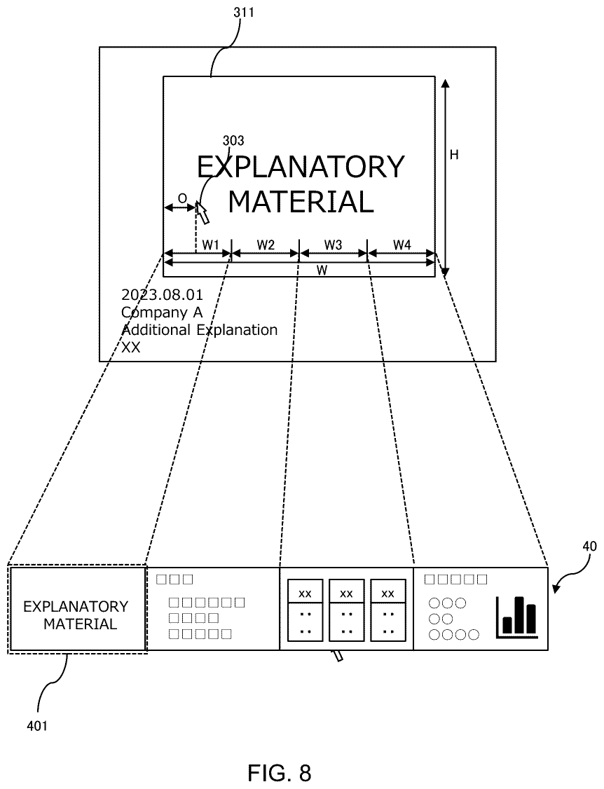

The enlarging display unit 114 can determine the page to be displayed according to the position of the pointer between one end and the other end of the enlarged display frame in the left-right direction (or top-bottom direction when arranged vertically). The one end and/or the other end may be at a position within or outside a predetermined distance from the left-right or top-bottom ends of the display frame. FIG. 8 illustrates the page determination. As shown in FIG. 8, the enlarging display unit 114 sets intervals W1 to W4 by dividing the width W of image 311 by a number corresponding to the number of pages (in the example of concatenated image 40 shown in FIG. 4, the total number of pages “4”). The number of pages may be the total number of pages in the document data. The number of pages may be the total number of pages minus a predetermined number (for example, subtracting one page for the front or back cover, subtracting two pages for front and back covers, subtracting the number of pages in the table of contents section, subtracting the number of pages for the front and/or back covers and table of contents section, subtracting a predetermined number of pages from the first and/or last pages, etc.). The number of pages may be a fixed number (for example, 50 pages). The number of pages may be set to the total number of pages or the total number minus a predetermined number (as above) up to a predetermined maximum value, and when the total number of pages exceeds the predetermined maximum value, it may be set to a fixed number (for example, the maximum value). The number of pages may be set in steps according to the range of the total number of pages in the document data. For example, the division may be made by a number less than the maximum number of pages for each range, such as 5 divisions for up to 10 pages and 50 divisions for 10-100 pages, or by the maximum number of pages for each range, such as 10 divisions for up to 10 pages and 100 divisions for 10-100 pages. The intervals may also be unequal. For example, the size of the intervals can be set to increase closer to the beginning, closer to the center, or closer to the end. Also, intervals may be set with sizes according to the importance of pages in the document data (for example, larger for higher importance). For page importance, if the document data is structured, the importance of items such as table of contents and index can be lowered. Additionally, importance can be set for each chapter and page for each document data, and interval sizes can be set according to pre-configured importance. Furthermore, importance can be inferred by inputting chapter or page content into a machine learning model created through machine learning using chapter and page content and importance as training data. Also, importance of pages can be generated by providing a large language model with a prompt that includes the page content and a query about page importance. The enlarging display unit 114 determines which of the intervals W1 to W4 the horizontal position of pointer 303 falls into. In the example in FIG. 8, it falls into interval W1. The page corresponding to this interval W1 can be determined as the page to be extracted from the concatenated image.

The enlarging display unit 114 displays a page image cut out from the range corresponding to the identified page in the concatenated image. The enlarging display unit 114 calculates w=W÷N and P=floor (O÷w), where O is the offset distance of pointer 303 from the left edge of image 311, N is the number of pages (which, as mentioned above, may be the total number of pages in the document data, a fixed number, or a number determined by other predetermined functions), w is the length of intervals W1 to W4 (page width) (which can be set as Wi1 to Wi4 for the i-th page length when set unequally), and H is the height of the page image. The enlarging display unit 114 can calculate the concatenated image cutout range=(w×P, 0)−(w×P+w, H). In the example in FIG. 8, page image 401 is cut out and displayed as image 311 in the dialog.

If the concatenated image is created so that it wraps around at a predetermined number M, the cutout range of the concatenated image can be calculated by the following calculation, assuming that the offset distance of the pointer 303 from the left edge of image 311 is Ox and the offset distance of the pointer 303 from the top edge of image 311 is Oy.

$$Px = floor ( Ox / w )$$

$$Py = floor ( Oy / H )$$

$$The concatenated image cutout range = ( w \times Px , H \times Py ) - ( w \times Px + w , H \times Py + H )$$

### Operation

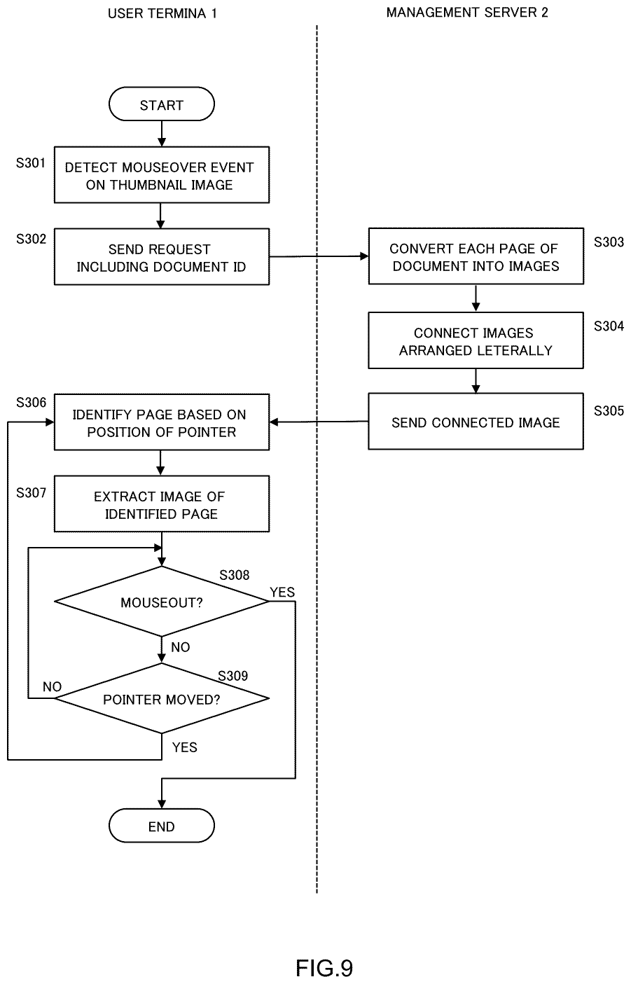

FIG. 9 illustrates the operation of the information processing system. The processing in FIG. 9 starts after the screen 30 based on the screen data is displayed.

User terminal 1 detects a mouse-over event on the thumbnail image (S301), identifies the document ID of the thumbnail image in which the event occurred, for example, from the ID attribute of the element in the thumbnail image, and sends a request for a concatenated image including the identified document ID to management server 2 (S302).

The management server 2 reads the concatenated image indicated by the document ID included in the request from the document data storage unit 231 and sends the read concatenated image to the user terminal 1 (S305). If the document data storage unit 231 is managed by an external server, such as cloud storage, for example, the user terminal 1 can send a request (e.g., HTTP request) to the external server. In this case, the document ID can be encoded in the URL of the access destination. If the concatenated image data has not been created in advance, the management server 2 reads the document data from the document data storage unit 231 in step S302. After step S302, the management server 2 can perform two steps: acquiring images of each page contained in the read document data (S303) and creating a concatenated image by arranging the images side by side (S304).

The user terminal 1 receives the concatenated image, identifies the page to be displayed based on the pointer position (S306), and cuts out the image of the identified page from the concatenated image and displays it (S307). If user terminal 1 detects a mouse-out event from the dialog (S308: YES), the processing ends. If the pointer is moved (S309: YES), user terminal 1 repeats the processing from S306.

As described above, according to this information processing system, by hovering the pointer over a thumbnail image, the pages included in the document data that are displayed as thumbnails can be enlarged and displayed, and by moving the pointer horizontally, the pages can be switched. This allows users to efficiently check the contents of document data.

The above description of the embodiment is intended to facilitate understanding of the invention and is not intended to be interpreted as limiting the invention. The invention may be changed and improved without departing from its spirit, and the invention also includes equivalents thereof.

For example, in this embodiment, document data is assumed to include pages, but it may be data that changes over time, such as video or audio. In this case, user terminal 1 can extract and display a single frame that constitutes a video as a page image. For video and audio, user terminal 1 can also identify a playback start position according to the pointer position and start playback from the identified position.

In this embodiment, while the enlarging display unit 114 changes the page displayed on the enlarged display section (dialog) according to the pointer movement on the enlarged page, it may also be configured to change the image displayed as a thumbnail image according to the pointer movement on the thumbnail image displayed by the screen display unit 112 without enlargement. In this case, a concatenated image can be created for each thumbnail image displayed on the screen, and the screen display unit 112 can extract one page (initially the display page) from the concatenated image and display it on the screen, and can also change the image displayed as a thumbnail image according to the pointer movement on the thumbnail image. The screen display unit 112 can determine which page to display based on which interval the pointer is positioned in, where the intervals are obtained by dividing the width or height of the thumbnail image by the number of pages. Additionally, the screen display unit 112 may advance or reverse the pages by the number of pages corresponding to the pointer's movement distance or movement speed.

Also, while this embodiment describes transmitting a concatenated image, page images may be transmitted without creating a concatenated image. Multiple page images can be transmitted in advance and cached in user terminal 1. In this case, instead of cutting out page images from the concatenated image, the enlarging display unit 114 can either receive the required page images from the management server 2, or extract the page image corresponding to the relevant page from the cache of page images previously received from the management server 2.

### Disclosures

The disclosure also includes the following configurations.

### Item 1

An information processing system comprising:
a screen display unit that displays a document image showing document data including multiple pages on a screen; and
an enlarging display unit that enlarges and displays one of the plurality of pages of the document data when the pointer is hovered over the document image, and changes the page to be displayed according to the movement of the pointer on the displayed page.

### Item 2

The information processing system according to Item 1, comprising:
a concatenated image creation unit that generates page images showing each of the plurality of pages contained in the document data, and creates a concatenated image by arranging the generated page images in one direction,
wherein the enlarging display unit displays a portion of the concatenated image when the pointer is hovered over the document image, and changes the portion of the concatenated image to be displayed in response to movement of the pointer on the displayed portion.

### Item 3

The information processing system according to Item 1,
wherein the enlarging display unit determines the page to be displayed according to the position of the pointer between one end and the other end of the enlarged display frame in either left-right direction or top-bottom direction.

### Item 4

An information processing method executed by a computer, comprising:
displaying on the screen a document image showing document data including multiple pages; and
enlarging and displaying one of the plurality of pages of the document data when the pointer is located on the document image, and changing the page to be displayed according to the movement of the pointer on the displayed page.

### Item 5

A program for causing a computer to execute:
displaying on the screen a document image showing document data including multiple pages; and
enlarging and displaying one of the plurality of pages of the document data when the pointer is located on the document image, and changing the page to be displayed according to the movement of the pointer on the displayed page.

### REFERENCE SIGNS LIST

1: User terminal
2: Management server

1. An information processing system comprising:
a screen display unit that displays a document image representing document data including a plurality of pages on a screen; and
an enlarging display unit that, when a pointer is located on the document image, enlarges one of the plurality of pages of the document data and changes the page to be displayed according to a movement of the pointer on the displayed page,
wherein the enlarging display unit determines the page to be displayed based on which section the position of the pointer falls within, the sections being obtained by dividing a range from one end to the other end of the enlarged display frame in a left-right direction or a top-bottom direction by the number of pages.

2. The information processing system according to claim 1, comprising:
a concatenated image creation unit that generates a page image showing each of the plurality of pages included in the document data, and creates a concatenated image in which the generated page images are aligned in one direction,
wherein the enlarging display unit displays one page image cut out from the concatenated image when the pointer is located on the document image, and changes the page image to be cut out from the concatenated image according to movement of the pointer on the displayed page image.

3. An information processing method executed by a computer, comprising:
displaying a document image representing document data including a plurality of pages on a screen; and
enlarging and displaying one of the plurality of pages of the document data when a pointer is located on the document image, and changing the page to be displayed according to a movement of the pointer on the displayed page,
wherein in the step of changing, the computer determines the page to be displayed based on which section the position of the pointer falls within, the sections being obtained by dividing a range from one end to the other end of the enlarged display frame in a left-right direction or a top-bottom direction by the number of pages.

4. The information processing method according to claim 3,
wherein the computer further executes a step of generating a page image showing each of the plurality of pages included in the document data, and creating a concatenated image in which the generated page images are aligned in one direction,
wherein in the step of changing, the computer displays one page image cut out from the concatenated image when the pointer is located on the document image, and changes the page image to be cut out from the concatenated image according to movement of the pointer on the displayed per image.

5. A non-transitory computer-readable storage medium storing a program for causing a computer to execute a process comprising:
displaying a document image representing document data including a plurality of pages on a screen; and
enlarging and displaying one of the plurality of pages of the document data when a pointer is located on the document image, and changing the page to be displayed according to a movement of the pointer on the displayed page,
wherein in the changing, the computer determines the page to be displayed based on which section the position of the pointer falls within, the sections being obtained by dividing a range from one end to the other end of the enlarged display frame in a left-right direction or a top-bottom direction by the number of pages.

6. The storage medium according to claim 5, wherein the process further comprises:
causing the computer to generate a page image showing each of the plurality of pages included in the document data, and create a concatenated image in which the generated page images are aligned in one direction,
wherein in the changing, the computer displays one page image cut out from the concatenated image when the pointer is located on the document image, and changes the page image to be cut out from the concatenated image according to movement of the pointer on the displayed page image.
